(19) United States
(12) Patent Application Publication
(10) Pub. No.: US 2023/0156026 A1
(43) Pub. Date: May 18, 2023

(54) SYSTEM AND METHOD OF AUTOMATIZING A THREAT ANALYSIS BASED ON ARTIFICIAL INTELLIGENCE

(71) Applicant: Korea Internet & Security Agency, Naju-si (KR)

(72) Inventors: Do Won KIM, Naju-si (KR); Tae Eun KIM, Naju-si (KR); Ki Jong SON, Naju-si (KR); Seul Ki CHOI, Naju-si (KR); Jong Ki KIM, Naju-si (KR)

(73) Assignee: Korea Internet & Security Agency, Naju-si (KR)

(21) Appl. No.: 17/972,634

(22) Filed: Oct. 25, 2022

(30) Foreign Application Priority Data
Nov. 17, 2021 (KR) 10-2021-0158551

(51) Int. Cl. H04L 9/40

(52) U.S. Cl. CPC H04L 63/1425; H04L 63/1416

(57) ABSTRACT

Disclosed is a system and a method of automatizing a threat analysis based on artificial intelligence according to the present invention, the system comprising: a playbook automatic-generation module configured to generate a playbook based on a template by utilizing an artificial learning model; a playbook verification and management module configured to verify effectiveness of the playbook generated by the playbook automatic-generation module; a playbook database configured to save the playbook verified by the playbook verification and management module; and a playbook execution module configured to automatically execute any playbook corresponding to a detected event through matching therebetween from the playbook database.

### CROSS-REFERENCE TO RELATED APPLICATION

This application claims priority to Korean Patent Application No. 10-2021-0158551, filed on Nov. 17, 2021, in the Korean Intellectual Property Office, the entire contents of which are hereby incorporated by reference.

### BACKGROUND OF THE INVENTION

### Field of the Invention

The prevent invention relates to a system and a method of automatizing a threat analysis based on artificial intelligence

### Description of the Related Arts

Security events have been rapidly increasing, whereas human efforts for carrying out analyzes and counter-affairs for these security events have currently reached limits. Recently, security management centers have introduce a security orchestration, automation, and response (SOAR) technology of automatizing the analysis and counter-affairs with playbooks. Although human efforts required for the analysis and the counter-affairs have largely reduced, the human efforts for developing and managing playbook have resulted in a waste of time.

### SUMMARY OF THE INVENTION

The present invention may provide a system and a method of automatizing a threat analysis based on artificial intelligence, which automatically generate a playbook by utilizing an artificial intelligence art, carrying out verification of effectiveness.

Furthermore, the present invention may provide a system and a method of automatizing a threat analysis based on artificial intelligence, which make a search for and execute a most suitable playbook when a security event occurs.

Furthermore, the present invention may provide a system and a method of automatizing a threat analysis based on artificial intelligence, which can cause a playbook to be reinforced in a state of being suitable for circumstances of a security management by utilizing published cyber threat intelligence (CTI) information and results of executing the playbook.

Furthermore, the present invention may provide a system and a method of automatizing a threat analysis based on artificial intelligence, which carry out a request for a selection of events for which a controller's intervention is required during execution of the playbook.

Furthermore, the present invention may provide a system and a method of automatizing a threat analysis based on artificial intelligence, which carry out a request for the selection of a most suitable countermeasure according to results of analyzing events.

In order to solve the problems, according to exemplary embodiments of the present invention, a system of automatizing a threat analysis based on artificial intelligence, the system may comprise: a playbook automatic-generation module configured to generate a playbook based on a template by utilizing an artificial learning model; a playbook verification and management module configured to verify effectiveness of the playbook generated by the playbook automatic-generation module; a playbook database configured to save the playbook verified by the playbook verification and management module; and a playbook execution module configured to automatically execute a playbook corresponding to a detected event through matching therebetween from the playbook database.

The playbook automatic-generation module may receive data concerning a counter-history inputted by a controller, extracting counter-acts from the data concerning the counter-history as components, generating a component set by analyzing connectivity among the extracted components based on graph theory, deciding order of the components within the component set based on reinforcement learning, generating a playbook template based on the order of the components within the component set decided, and generating a playbook based on the playbook template.

The playbook automatic-generation module may receive cyber threat intelligence (CTI) information from a data integration management system, TTP information from the CTI information, distinguishing a threatening factor based on the extracted TTP information from the other, generating a most suitable countermeasure through an MITRE frame walk analysis with respect to the distinguished threatening factor, and generating a playbook based on the playbook template through a connection with the TTP information.

The playbook automatic-generation module may receive a result of executing the playbook from the data integration management system, extracting a reinforcement learning feature from the result of executing the playbook, carrying out evaluation on the playbook based on the extracted reinforcement learning feature, deciding whether or not to apply reinforcement learning based on a result of evaluating the playbook, adjusting the playbook by applying a reward function when the reinforcement learning is decided to be applied, and generating an adaptable playbook via a reinforcement learning process when the reinforcement learning is decided not to be applied.

The playbook verification and management module may decide whether or not effectiveness passes verification through an analysis on similarity among the generated playbook and an analysis on effectiveness of component execution.

The playbook execution module may generate materialized information on a playbook execution process, transmitting a result of matching the corresponding playbook with the detected event to a decision-making support system, and transmitting a result of executing the playbook to the data integration management system.

The playbook execution module may request the decision-making support system to select an event to be preferentially processed among events which are ready for analyzes in case that intervention of a controller is required, requesting the decision-making support system to render a most suitable countermeasure.

The playbook execution module may request a security threat automatic-response system to apply a security policy in case that there is necessary to apply the security policy.

The playbook execution module may request the decision-making support system to render a most suitable countermeasure, and transmits the result of executing the playbook to the data integration management system.

According to exemplary embodiment of the present invention, a method of automatizing a threat analysis based on artificial intelligence, the method may comprise: a step of generating a playbook based on a template by utilizing an artificial learning model; a step of verifying effectiveness of the playbook generated; a step of saving the playbook whose effectiveness is verified in a playbook database; and a step of making a search for any playbook matched with an event detected from the playbook database when the detected event is received.

The step of generating the playbook may comprise: a step of receiving data concerning a counter-history inputted by a controller; a step of extracting counter-acts from the data concerning the counter-history as components; a step of generating a component set by analyzing connectivity among the extracted components based on graph theory; a step of deciding order of the components within the component set on the basis of reinforcement learning; a step of forming a playbook template based on the order of the components within the component set; and a step of generating a playbook based on the playbook template.

The step of generating the playbook may further comprise: a step of receiving CTI information from a data integration management system; a step of extracting TTP information from the CTI information; a step of distinguishing a threatening factor based on the extracted TTP information from the other; and a step of generating a most suitable countermeasure through an MITRE frame walk analysis with respect to the distinguished threatening factor; a step of generating playbook on the basis of the playbook template by a connection with the TTP information.

The step of generating the playbook may further comprise: a step of receiving a result of playbook execution from the data integration management system; a step of extracting a reinforcement learning feature from the result of playbook execution; a step of carrying out evaluation on the playbook based on the extracted reinforcement learning feature; a step of deciding whether or not apply reinforcement learning based on a result of evaluating the playbook; a step of adjusting the playbook by applying a reward function when the reinforcement learning is decided to be applied; and a step of generating an adaptable playbook through a reinforcement learning process when the reinforcement learning is decided not to be applied.

The step of verifying the effectiveness may comprises a step of deciding whether or not effectiveness passes verification through an analysis on similarity among the generated playbook, and an analysis on the effectiveness of component execution.

The step of automatically executing the playbook may comprises: a step of generating materialized information about a process of executing the playbook; a step of transmitting a result of matching the corresponding playbook with the detected event to a decision-making support system; and a step of transmitting a result of playbook execution to the data integration management system.

The present invention can prepare and provide an environment which can cause security control human power (controllers) to concentrate upon only importance security events, and to perform analyses and confrontations in such a manner as to automatically generate and verify a playbook by utilizing an artificial intelligence art, and to reinforce the playbook in a state of being consistent with security control centers' characteristics.

Furthermore, the present invention can solve problems which show that different analyzes, counter-procedures or levels are generated differently according to a difference in expertness among security controllers, and different playbook are developed differently.

### BRIEF DESCRIPTION OF THE DRAWINGS

FIG. 1 is a block diagram illustrating a threat analysis automation system according to some exemplary embodiment of the present invention.

FIG. 2 is a flow chart illustrating a method of automatically generating a playbook according to some exemplary embodiment of the present invention.

FIG. 3 is a flow chart illustrating a method of reinforcing a playbook according to a first exemplary embodiment.

FIG. 4 is a flow chart illustrating a method of reinforcing a playbook according to a second exemplary embodiment.

FIG. 5 is a flow chart illustrating a method of verifying effectiveness of the playbook according to some exemplary embodiments.

FIG. 6 is an exemplary view illustrating the graphed playbook according to some exemplary embodiment.

FIG. 7 is a flow chart illustrating a method of executing the playbook automatically.

### DETAILED DESCRIPTION OF THE INVENTION

The terms “comprise”, “configure”, “have”, and so on described in the present specification mean should be construed as further comprising other constituent elements rather than excluding the existence of the other constituent elements because they mean that the corresponding constituent elements can be inherently provided, unless the context clearly indicates otherwise.

Furthermore, each of the terms “˜part”, “module”, and so on descried herein means a unit of handling at least one function or operation, which can be embodied in the form of hardware or software, or a combination of the hardware and the software. Furthermore, the meanings of the articles “a”, “an”, and “the” and so on can be intended to include all the singular forms and the plural forms, unless the context describing the present invention in the present specification clearly indicates otherwise, or clearly refutes.

Hereinafter, exemplary embodiments of the present invention are described in detail with reference to the accompanying drawings.

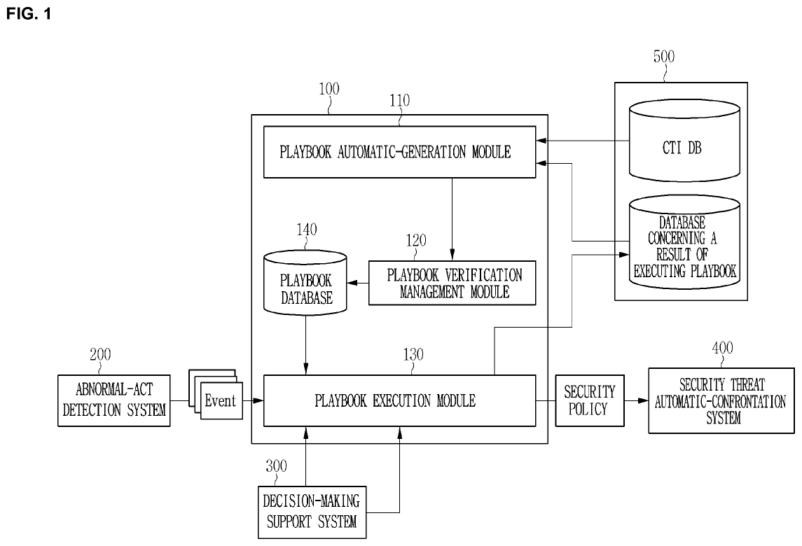

FIG. 1 is a block diagram illustrating a threat analysis automation system according to some exemplary embodiments of the present invention.

A threat analysis automation system 100 may be connected to an abnormal-act detection system 200, a decision-making support system 300, a security threat automatic-response system 400, and a data integration management system 500 via a network.

The data integration management system 500 may comprise: a cyber threat intelligence (CTI) database 510 configured to save and manage published cyber threat intelligence (CTI) information; and a playbook execution result database 520 configured to save and manage a result of executing a playbook.

The CTI information is cyber threat information in a non-standard form. The result of executing the playbook may include playbook matching information, information on execution time, error information, corrected information, manual analysis information, and so on. Each system 100, 200, 300, 400, or 500 may comprise a communications circuit, a memory, and a processor.

The communications circuit may support cable and wireless communications among the systems 100 to 500.

The memory may save logic (algorism) carrying out a predetermined function, data and/or various kinds of fixed information, and so on. The memory may comprise a storage medium, such as a flash memory, a hard disk, a solid state disk (SSD), a random access memory (RAM), a static random access memory (SRAM), a read only memory (ROM), a programmable Read Only memory (PROM), an electrically erasable and programmable (ROM), an erasable and programmable ROM (EPROM) and/or an embedded multimedia card (eMMC), and so on.

The processor may control the whole operation of each system 100, 200, 300, 400, or 500. The processor may be embodied into at least one among processing devices, such as an application specific integrated circuit (ASIC), a digital signal processor (DSP), a programmable logic device (PLD), a field programmable gate array (FPGA), a central processing unit (CPU), a microcontroller and/or a microprocessor.

The threat analysis automation system 100 may match a playbook for an automated and detailed analysis with an event to be detected based on playbooks previously defined according to each event, thereby automatically executing the playbook. The threat analysis automation system 100 may request the decision-making support system 300 to render the priority order of events to be preferentially processed for which a controller's intervention is required. The threat analysis automation system 100 may request the decision-making support system 300 to render a most suitable countermeasure on the basis of a result of analyzing the events. The threat analysis automation system 100 may automatically generate a playbook based on machine learning (ML), and may verify and manage effectiveness of the automatically generated playbook.

The threat analysis automation system 100 may comprise: a playbook automatic-generation module 110; a playbook verification and management module 120; a playbook database 130; and a playbook execution module 140.

The playbook automatic-generation module 110 may automatically generate a playbook template on the basis of a component selection and an order arrangement based on graph theory and reinforcement learning (RL), and evaluation data rendered by a security control expert. The playbook automatic-generation module 110 may receive data concerning a counter-history inputted by a controller. The playbook automatic-generation module 110 may generate component information by extracting components from the counter-history data. The playbook automatic-generation module 110 may generate information on connectivity among the components by analyzing the connectivity among the components. The playbook automatic-generation module 110 may generate a playbook template based on information on the components, and the information on the connectivity among the components.

The playbook automatic-generation module 110 may automatically generate a playbook based on a template by utilizing an artificial intelligence (AI) learning model. The playbook automatic-generation module 110 may receive new CTI information from the data integration management system 500. The playbook automatic-generation module 110 may generate tactics, techniques, procedure (TTP) based on the received new CTI information. In other words, the playbook automatic-generation module 110 may extract TTP information from the CTI information. The playbook automatic-generation module 110 may distinguish a threat factor from the other by carrying out an analysis based on the generated TTP information. The playbook automatic-generation module 110 may generate a playbook concerning the distinguished threat factor. The playbook automatic-generation module 110 may automatically generate the playbook based on a template.

The playbook automatic-generation module 110 may reinforce the playbook by utilizing the data concerning the result of executing the playbook during the operation of security orchestration, automation, and response (SOAR). The playbook automatic-generation module 110 may automatically generate the playbook based on reinforcement learning (RL). The playbook automatic-generation module 110 may request the data integration management system to render the playbook execution result required for reinforcement of the playbook. The playbook automatic-generation module 110 may receive the playbook execution result from the data integration management system 500. The playbook automatic-generation module 110 may analyze the received playbook execution result. The playbook automatic-generation module 110 may extract a feature required for reinforcement learning from the playbook execution result. The playbook automatic-generation module 110 may collect evaluation data rendered by an expert with respect to the playbook execution result. The playbook automatic-generation module 110 may generate an adaptable playbook suitable to security operations center (SOC) circumstances based on playbook execution (operation) data.

The playbook automatic-generation module 110 may request the playbook verification and management module 120 to verify effectiveness of the generated playbook. The playbook automatic-generation module 110 may request the playbook verification and management module 120 to verify effectiveness of the playbook generated on the basis of the template, or effectiveness of the playbook generated on the basis of reinforcement learning.

The playbook verification and management module 120 may carry out the verification of effectiveness concerning the playbook generated from the playbook automatic-generation module 110 according to the request of the playbook automatic-generation module 110. The playbook verification and management module 120 may carry out the verification of effectiveness based on a similarity analysis, a simulation and/or data actually proved by security control.

When a playbook management event (for example, a correction, and a deletion, and so on) occurs, the playbook verification and management module 120 may take a measure for the corresponding event generated. The playbook verification and management module 120 may be in preparation for the generation and change of playbook resulting from the generation, change, deletion, and so on of components. The playbook verification and management module 120 may insert tag information into a component and may carry out component clustering based on an unsupervised learning (UL) model.

The playbook database 140 may save a playbook whose effectiveness is verified by the playbook verification and management module 120. The playbook database 140 may save and manage a list of playbook which can be executed.

The playbook execution module 130 may receive a detected event from the abnormal-act detection system 200. The playbook execution module 130 may match a playbook corresponding to the detected event with the other playbook, and may automatically execute the matched playbook. The playbook execution module 130 may generate visualization information for monitoring a process of executing the playbook.

The playbook execution module 130 may transmit the detected event and information about matching of the playbook to the decision-making support system 300. The detected event and the playbook matching information may be utilized when there is a request for preferential processing of an event.

The playbook execution module 130 may request the decision-making support system 300 to select an event to be preferentially processed among events which are ready for analyzes. The playbook execution module 130 may request the decision-making support system 300 to select an event to be preferentially processed when a situation in which intervention of the controller is required occurs.

The playbook execution module 130 may request the decision-making support system 300 to render a most suitable countermeasure against a threat analyzed. When there is necessary to select a security policy for security device with respect to the most suitable countermeasure, the playbook execution module 130 may request the security threat automatic-response system 400 to apply the corresponding policy. The playbook execution module 130 may transmit all the information, which occurred during execution of the playbook, as a result of the execution of the playbook to the data integration management system 500.

The playbook execution module 130 may transmit data concerning the playbook execution result required for reinforcement of the playbook to the data integration management system 500.

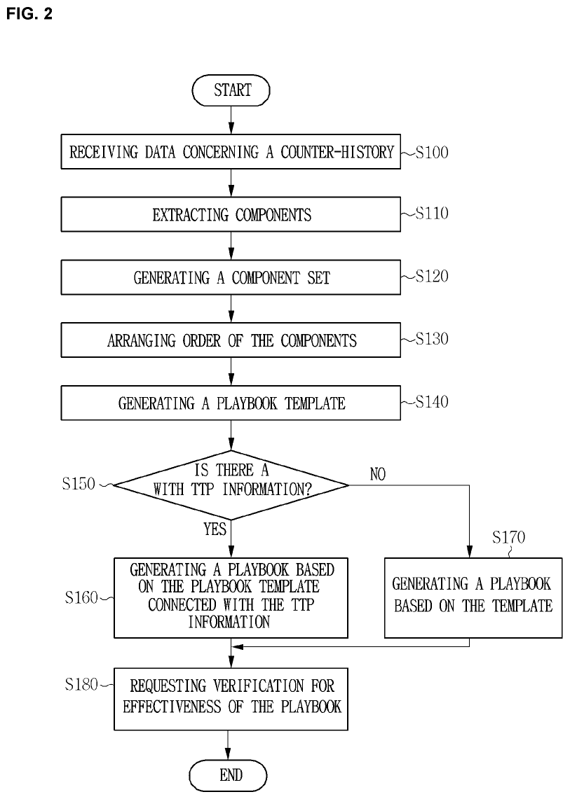

FIG. 2 is a flow chart illustrating a method of automatically generating playbook according to some exemplary embodiments of the present invention.

Referring to FIG. 2, the playbook automatic-generation module 110 may receive data regarding a counter-history inputted by a controller S100. The playbook automatic-generation module 110 may receive the counter-history data as information on playbook generation.

The playbook automatic-generation module 110 may extract counter-acts from the counter-history data as components S110.

The playbook automatic-generation module 110 may generate a component set by analyzing connectivity among the components based on graph theory S120.

The playbook automatic-generation module 110 may decide (arrange) order of the components in the component set based on reinforcement learning S130. In the initial stage of development for playbook, a target of a reward function may be set up as a copy of the existing confrontations rendered by experts. After the development of the playbook is completed, the target of the reward function may be set by evaluation marks from experts.

The playbook automatic-generation module 110 may generate a playbook template as a general procedure against a threat through a result of extracting the components and an order arrangement S140. The playbook automatic-generation module 110 may generate a playbook template based on a result of arranging the order of the components in the component set.

The playbook automatic-generation module 110 may decide whether or not to carry out a connection with the TTP information S150. The playbook execution module 130 may decide a connection with the TTP information in case that there is new TTP information.

When deciding carrying out a connection with the TTP information, the playbook automatic-generation module may generate a playbook based on a template by being connected with the TTP information S160. The playbook automatic-generation module 110 may generate a playbook by defining detailed work based on the playbook template in consideration of the TTP information.

When not deciding to carry out a connection with the TTP information, the playbook automatic-generation module 110 may generate a playbook based on a template S170. The playbook automatic-generation module 110 may generate a playbook by defining detail work based on a general procedure against a threat.

The playbook automatic-generation module 110 may request the playbook verification and management module 120 to verify effectiveness of the generated playbook S180.

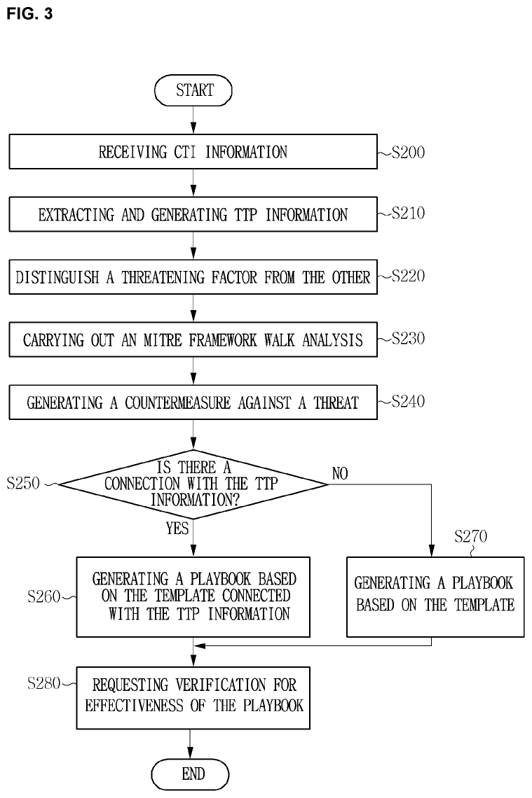

FIG. 3 is a flow chart illustrating a method of reinforcing a playbook according to a first exemplary embodiment.

The playbook automatic-generation module 110 may receive CTI information from the data integration management system 500 S200. The CTI information is threat information which has been previously published.

The playbook automatic-generation module 110 may generate TTP information by extracting it from the CTI information S210.

The playbook automatic-generation module 110 may distinguish a dangerous point, namely, a threatening factor by applying the TTP information to network circumstances to be protected S220.

The playbook automatic-generation module 110 may carry out an MITRE frame work analysis on the distinguished threatening factor S230. The playbook automatic-generation module 110 provide an attack method and a defense method mapped in the distinguished threatening factor through the MITRE frame work analysis.

The playbook automatic-generation module 110 may generate a most suitable countermeasure for network circumstances to be protected on the basis of the TTP information S240.

The playbook automatic-generation module 110 may decide to carry out a connection with the TTP information S250.

When deciding to carry a connection with the TTP information, the playbook automatic-generation module may generate a playbook based on a template by being connected with the TTP information S260. The playbook automatic-generation module 110 may generate a playbook by defining detailed work based on the playbook template generated in step S140 shown in FIG. 2 in consideration of the TTP information.

When not deciding to carry out a connection with the TTP information, the playbook automatic-generation module may generate a playbook based on a playbook template S270. The playbook automatic-generation module 110 may generate a playbook by defining detailed work based on a general procedure against a threat. The general procedure against a threat may be the playbook template generated in step S140 shown in FIG. 2.

The playbook automatic-generation module 110 may request the playbook verification and management module 120 to verify effectiveness of the generated playbook S280.

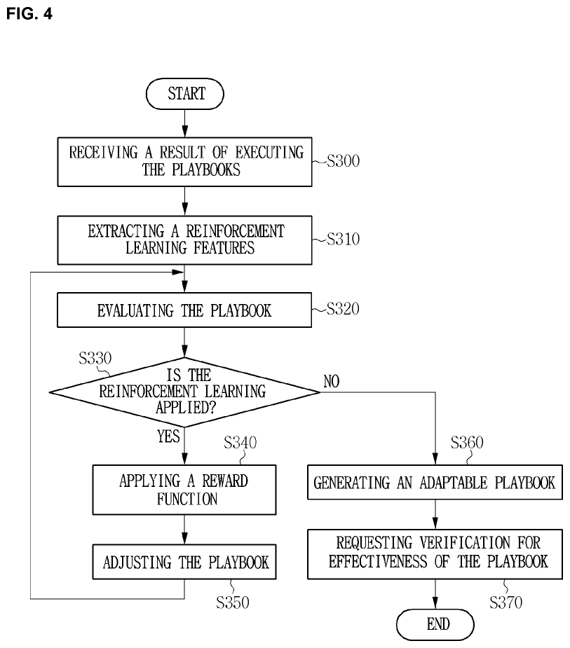

FIG. 4 is a flow chart illustrating a method of reinforcing a playbook according to a second exemplary embodiment.

The playbook automatic-generation module 110 may receive a result of executing a playbook from the data integration management system 500 S300.

The playbook automatic-generation module 110 may extract a reinforcement learning feature from the playbook book execution result S310.

The playbook automatic-generation module 110 may carry out evaluation on the playbook based on the extracted reinforcement learning feature S320.

The playbook automatic-generation module 110 may decide whether or not to apply reinforcement learning based on the result of evaluating the playbook S330.

When deciding to apply the reinforcement learning, the playbook automatic-generation module 110 may apply a reward function thereto. A target of the reward function may be set up to become different according operating circumstances.

The playbook automatic-generation module 110 may adjust the playbook based on data (i.e., an execution history) regarding the result of executing the playbook by being aimed at the applied reward function S350.

When deciding not to apply the reward function, the playbook automatic-generation module may generate an adaptable playbook through a process of reinforcement learning S360. The playbook automatic-generation module 110 may re-adjust the playbook through step S320 to step S350 that it is suitable to the operating circumstance.

The playbook automatic-generation module 110 may request the playbook verification and management module 120 to verify effectiveness of the generated playbook S370.

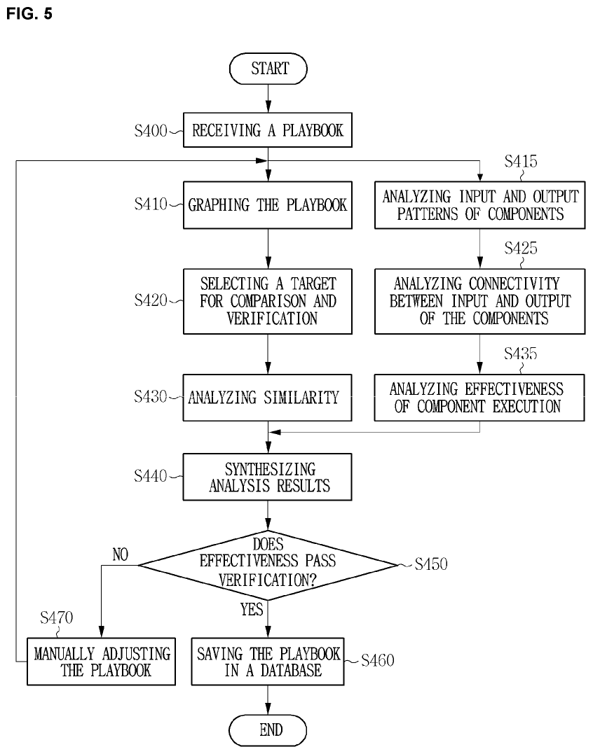

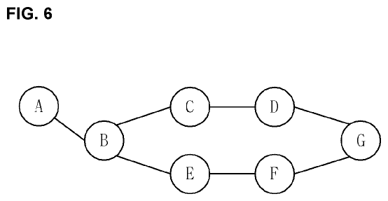

FIG. 5 is a flow chart illustrating a method of verifying effectiveness of playbook according to another exemplary embodiment. FIG. 6 is an exemplary view illustrating a grape of the playbook according to another exemplary embodiments.

Referring to FIG. 5, the playbook verification and management module 120 may receive the playbook from the playbook automatic-generation module 110 S400.

The playbook verification and management module 120 may make a graph of the received playbook S410. The playbook verification and management module 120 may transform the playbook into the graph to carry out an analysis on graph similarity based on graph theory. For example, when playbook′ codes are as follows, the playbook verification and management module 120 may transform the playbook into the graph as shown in FIG. 6.

### Examples of Playbook Codes

\textcircled{1} carrying out of component A

\textcircled{2} carrying out of component B

\textcircled{3} in case of condition 1

\textcircled{4} carrying out of component C

\textcircled{5} carrying out of component D

\textcircled{6} else:

\textcircled{7} carrying out of component E

\textcircled{8} carrying out of component F

\textcircled{9} carrying out of component G

The playbook verification and management module 120 may select playbook whose effectiveness should be verified (playbook to be verified), and comparative targets for a similarity analysis S420. The playbook verification and management module 120 may select any playbook from playbook which has already been collected and generated by an expert. The playbook verification and management module 120 may select any one playbook among playbooks previously saved in the playbook database 140.

The playbook verification and management module 120 may analyze graph similarity of the playbook to be verified and graph similarity of the playbook to be compared S430. The playbook verification and management module 120 may analyze similarity between graphs of the playbook selected as comparative targets in step S420.

The playbook verification and management module 120 may analyze input and output types of the components S415. The playbook verification and management module 120 may analyze each type of input information and output information of the components.

The playbook verification and management module 120 may analyze connectivity of input and output of the components S425. The playbook verification and management module 120 may analyze connectivity of the input information and the output information between each of the components. For example, in case of a connection being performed in order of from component A to component B, the playbook verification and management module 120 may analyze whether or not an output value of component A can be connected to an input value of component B.

The playbook verification and management module 120 may analyze effectiveness of component execution S435. The playbook verification and management module 120 may analyze whether or not to execute the components, and connectivity among the components by actually executing the components.

The playbook verification and management module 120 may synthesize a result of a similarity analysis and a result of analysis on effectiveness of component execution together S440.

The playbook verification and management module 120 may decide whether or not to pass the verification of effectiveness S450. The playbook verification and management module 120 may decide whether or not to pass the verification of effectiveness concerning the playbook whose effectiveness should be verified based on the synthesized analysis result.

In case that the playbook don't pass the verification for effectiveness thereof, the playbook verification and management module 120 may save the corresponding playbook in the playbook database 140 S460.

In case that the playbook don't pass the verification for effectiveness thereof, the playbook verification and management module 120 may manually adjust the corresponding playbook S470. The playbook verification and management module 120 may adjust the playbook by utilizing data which fail to verify effectiveness.

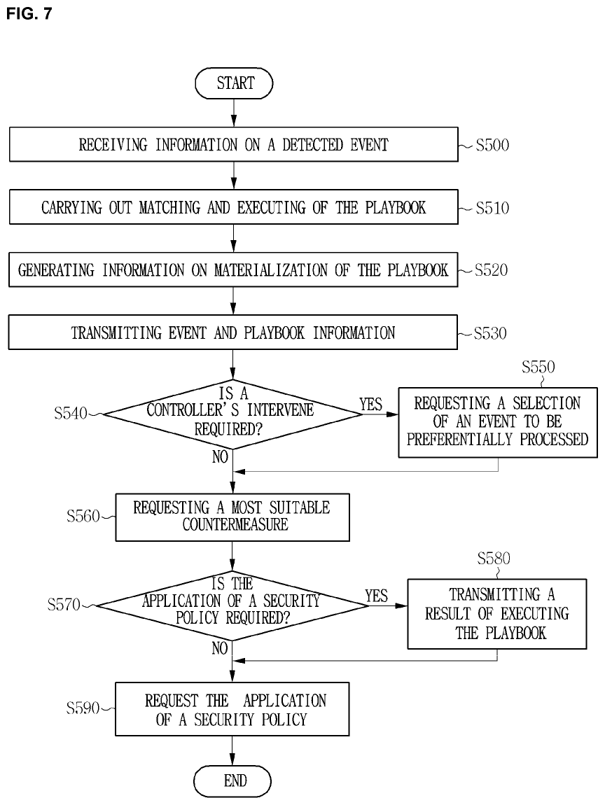

FIG. 7 is a flow chart illustrating a method of automatically executing playbook according to another exemplary embodiment of the present invention.

The playbook execution module 130 may receive information on detected events from the abnormal-act detection system 200 S500.

The playbook execution module 130 may carry out matching and execution of the playbook based on the received information on the detected events S510. The playbook execution module 130 may make a search for any playbook matched with the received information on the detected events through the playbook database 140. The playbook execution module 130 may access the searched playbook in the playbook database 140, thereby carrying out execution of the playbook.

The playbook execution module 130 may generate information on materialization of the playbook which is in execution S520. The playbook execution module 130 may generate a process of execution the playbook as materialization information.

The playbook execution module 130 may transmit event information and playbook information to the decision-making support system 300 S530. The event information and the playbook information may be utilized in selection of events to be preferentially processed, or request for a most suitable countermeasure.

The playbook execution module 130 may judge whether or not intervention of a controller is required S540.

When judging that the intervention of the controller is not required, the playbook execution module 130 may request the decision-making support system 300 to select events to be preferentially processed S550. Under a situation, in which the intervention of the controller is required, such as the controller or manager's approval, an analysis from which it is impossible to perform automation, a stop of component execution, and so on, the playbook execution module 130 may request a selection of events to be preferential processed. The playbook execution module 130 may not carry out step S550 in case that the intervention of the controller is not required. The decision-making support system 300 may transmit the selection of the events to be preferentially processed in response to the request of the playbook execution module 130 to the playbook execution module 130

The playbook execution module 130 may request the decision-making support system 300 to select events to be preferentially processed.

The playbook execution module 130 may request the decision-making support system 300 to render a most suitable countermeasure after analyzing the detected events S560. The playbook execution module 130 may request a most suitable countermeasure in case that different countermeasures are generated differently according to each target to be controlled with respect to the same events, or in case that different countermeasures are generated differently according to each time, day and/or period with respect to the same events. The decision-making support system 300 may transmit the most suitable countermeasure in response of the request rendered by the playbook execution module 130 to the playbook execution module 130.

The playbook execution module 130 may judge whether or not there is necessary to apply the security countermeasure S570.

The playbook execution module 130 may request the security threat automation confrontation system 400 to apply the security response in case that there is necessary to apply the security countermeasure S580. The automation response system 400 may manage a device to which the security countermeasure is applied, a rule for application of the security countermeasure, information required for generating the rule (e.g., an IP, a file name, and so on), and so on. The playbook execution module 130 may not carry out step S580 in case that there is not necessary to the security countermeasure.

The playbook execution module 130 may transmit a result of executing the playbook (execution result data) to the data integration management system 500 S590.

As described above, although it is described that all the constituent elements, which form the exemplary embodiments of the present invention, are combined into one, or operate in a state of being combined with one another, the present invention is not necessarily limited to these exemplary embodiments. That is, all the constituent elements may operate in a state of one or more constituent elements being selectively combined with each other, if this falls within the scope of the purpose of the present invention. Also, all the constituent elements may be embodied into their respective independent hardware, or may be embodied into a computer program having a program module which perform some functions or all the functions mixed in one piece or a plurality pieces of hardware in a state of some or all of the constituent elements being mixed selectively. Codes and code segments which forms the computer program could be easily derived by those having ordinary skill in the technical field of the present invention. This computer program may be saved in a computer readable media, may be readable and may be executed by a computer so that the exemplary embodiments of the present invention can be embodied.

What is claimed is:

1. A system of automatizing a threat analysis based on artificial intelligence, the system comprising:
a playbook automatic-generation module configured to generate a playbook based on a template by utilizing an artificial learning model;
a playbook verification and management module configured to verify effectiveness of the playbook generated by the playbook automatic-generation module;
a playbook database configured to save the playbook verified by the playbook verification and management module; and
a playbook execution module configured to automatically execute a playbook corresponding to a detected event through matching therebetween from the playbook database.

2. The system of claim 1, wherein the playbook automatic-generation module
receives data concerning a counter-history inputted by a controller,
extracting counter-acts from the data concerning the counter-history as components,
generating a component set by analyzing connectivity among the extracted components based on graph theory,
deciding order of the components within the component set based on reinforcement learning,
generating a playbook template based on the order of the components within the component set decided, and
generating a playbook based on the playbook template.

3. The system of claim 2, wherein the playbook automatic-generation module
receives cyber threat intelligence (CTI) information from a data integration management system,
extracting TTP information from the CTI information,
distinguishing a threatening factor based on the extracted TTP information from the other,
generating a most suitable countermeasure through an MITRE frame walk analysis with respect to the distinguished threatening factor, and
generating a playbook based on the playbook template through a connection with the TTP information.

4. The system of claim 1, wherein the playbook automatic-generation module
receives a result of executing the playbook from the data integration management system,
extracting a reinforcement learning feature from the result of executing the playbook,
carrying out evaluation on the playbook based on the extracted reinforcement learning feature,
deciding whether or not to apply reinforcement learning based on a result of evaluating the playbook,
adjusting the playbook by applying a reward function when the reinforcement learning is decided to be applied, and
generating an adaptable playbook via a reinforcement learning process when the reinforcement learning is decided not to be applied.

5. The system of claim 1, wherein the playbook verification and management module decides whether or not effectiveness passes verification through an analysis on similarity among the generated playbook and an analysis on effectiveness of component execution.

6. The system of claim 1, wherein the playbook execution module
generates materialized information on a playbook execution process,
transmitting a result of matching the corresponding playbook with the detected event to a decision-making support system, and
transmitting a result of executing the playbook to the data integration management system.

7. The system of claim 1, wherein the playbook execution module
requests the decision-making support system to select an event to be preferentially processed among events which are ready for analyzes in case that intervention of a controller is required,
requesting the decision-making support system to render a most suitable countermeasure.

8. The system of claim 1, wherein the playbook execution module requests a security threat automatic-response system to apply a security policy in case that there is necessary to apply the security policy.

9. The system of claim 1, wherein the playbook execution module requests the decision-making support system to render a most suitable countermeasure, and transmits the result of executing the playbook to the data integration management system.

10. A method of automatizing a threat analysis based on artificial intelligence, the method comprising:
a step of generating a playbook based on a template by utilizing an artificial learning model;
a step of verifying effectiveness of the playbook generated;
a step of saving the playbook whose effectiveness is verified in a playbook database; and
a step of making a search for any playbook matched with an event detected from the playbook database when the detected event is received.

11. The method of claim 10, wherein the step of generating the playbook comprises:
a step of receiving data concerning a counter-history inputted by a controller;
a step of extracting counter-acts from the data concerning the counter-history as components;
a step of generating a component set by analyzing connectivity among the extracted components based on graph theory;
a step of deciding order of the components within the component set on the basis of reinforcement learning;
a step of forming a playbook template based on the order of the components within the component set; and
a step of generating a playbook based on the playbook template.

12. The method of claim 11, wherein the step of generating the playbook further comprises:
a step of receiving CTI information from a data integration management system;
a step of extracting TTP information from the CTI information;
a step of distinguishing a threatening factor based on the extracted TTP information from the other;
a step of generating a most suitable countermeasure through an MITRE frame walk analysis with respect to the distinguished threatening factor; and
a step of generating playbook on the basis of the playbook template by a connection with the TTP information.

13. The method of claim 10, wherein the step of generating the playbook further comprises:
a step of receiving a result of playbook execution from the data integration management system;
a step of extracting a reinforcement learning feature from the result of playbook execution;
a step of carrying out evaluation on the playbook based on the extracted reinforcement learning feature;
a step of deciding whether or not apply reinforcement learning based on a result of evaluating the playbook;
a step of adjusting the playbook by applying a reward function when the reinforcement learning is decided to be applied; and
a step of generating an adaptable playbook through a reinforcement learning process when the reinforcement learning is decided not to be applied.

14. The method of claim 10, wherein the step of verifying the effectiveness comprises a step of deciding whether or not effectiveness passes verification through an analysis on similarity among the generated playbook, and an analysis on the effectiveness of component execution.

15. The method of claim 11, wherein the step of automatically executing the playbook comprises:
a step of generating materialized information about a process of executing the playbook;
a step of transmitting a result of matching the corresponding playbook with the detected event to a decision-making support system; and
a step of transmitting a result of playbook execution to the data integration management system.
